(19) United States
(12) Patent Application Publication
(10) Pub. No.: US 2014/0058168 A1
(43) Pub. Date: Feb. 27, 2014

(54) Methane Conversion Apparatus and Process with Improved Mixing Using a Supersonic Flow Reactor

(71) Applicant: UOP LLC, Des Plaines, IL (US)

(72) Inventors: Robert L. Bedard, McHenry, IL (US); Christopher Naunheimer, Arlington Heights, IL (US); Gavin P. Towler, Inverness, IL (US)

(73) Assignee: UOP LLC, Des Plaines, IL (US)

(21) Appl. No.: 13/966,752

(22) Filed: Aug. 14, 2013

Related U.S. Application Data
(60) Provisional application No. 61/691,298, filed on Aug. 21, 2012.

(51) Int. Cl. B01J 3/00

(52) U.S. Cl. CPC B01J 3/008
USPC 585/539; 422/128

(57) ABSTRACT

Apparatus and methods are provided for converting methane in a feed stream to acetylene. A supersonic reactor is used for receiving the methane feed stream and heating the methane feed stream to a pyrolysis temperature. A high temperature carrier stream passes through the reactor chamber at supersonic speeds. According to various aspects, a static mixer is provided for mixing the methane feed stream and the carrier stream.

### CROSS-REFERENCE TO RELATED APPLICATION

This application claims priority from Provisional Application No. 61/691,298 filed Aug. 21, 2012, the contents of which are hereby incorporated by reference in its entirety.

### FIELD

Apparatus and methods are disclosed for converting methane in a hydrocarbon stream to acetylene using a supersonic flow reactor. More particularly, methods and apparatus are provided for mixing of a feed stream with a carrier stream in a supersonic flow reactor.

### BACKGROUND

Light olefin materials, including ethylene and propylene, represent a large portion of the worldwide demand in the petrochemical industry. Light olefins are used in the production of numerous chemical products via polymerization, oligomerization, alkylation and other well-known chemical reactions. These light olefins are essential building blocks for the modern petrochemical and chemical industries. Producing large quantities of light olefin material in an economical manner, therefore, is a focus in the petrochemical industry. The main source for these materials in present day refining is the steam cracking of petroleum feeds.

The cracking of hydrocarbons brought about by heating a feedstock material in a furnace has long been used to produce useful products, including for example, olefin products. For example, ethylene, which is among the more important products in the chemical industry, can be produced by the pyrolysis of feedstocks ranging from light paraffins, such as ethane and propane, to heavier fractions such as naphtha. Typically, the lighter feedstocks produce higher ethylene yields (50-55% for ethane compared to 25-30% for naphtha); however, the cost of the feedstock is more likely to determine which is used. Historically, naphtha cracking has provided the largest source of ethylene, followed by ethane and propane pyrolysis, cracking, or dehydrogenation. Due to the large demand for ethylene and other light olefinic materials, however, the cost of these traditional feeds has steadily increased.

Energy consumption is another cost factor impacting the pyrolytic production of chemical products from various feedstocks. Over the past several decades, there have been significant improvements in the efficiency of the pyrolysis process that have reduced the costs of production. In a typical or conventional pyrolysis plant, a feedstock passes through a plurality of heat exchanger tubes where it is heated externally to a pyrolysis temperature by the combustion products of fuel oil or natural gas and air. One of the more important steps taken to minimize production costs has been the reduction of the residence time for a feedstock in the heat exchanger tubes of a pyrolysis furnace. Reduction of the residence time increases the yield of the desired product while reducing the production of heavier by-products that tend to foul the pyrolysis tube walls. However, there is little room left to improve the residence times or overall energy consumption in traditional pyrolysis processes.

More recent attempts to decrease light olefin production costs include utilizing alternative processes and/or feed streams. In one approach, hydrocarbon oxygenates and more specifically methanol or dimethylether (DME) are used as an alternative feedstock for producing light olefin products. Oxygenates can be produced from available materials such as coal, natural gas, recycled plastics, various carbon waste streams from industry and various products and by-products from the agricultural industry. Making methanol and other oxygenates from these types of raw materials is well established and typically includes one or more generally known processes such as the manufacture of synthesis gas using a nickel or cobalt catalyst in a steam reforming step followed by a methanol synthesis step at relatively high pressure using a copper-based catalyst.

Once the oxygenates are formed, the process includes catalytically converting the oxygenates, such as methanol, into the desired light olefin products in an oxygenate to olefin (OTO) process. Techniques for converting oxygenates, such as methanol to light olefins (MTO), are described in U.S. Pat. No. 4,387,263, which discloses a process that utilizes a catalytic conversion zone containing a zeolitic type catalyst. U.S. Pat. No. 4,587,373 discloses using a zeolitic catalyst like ZSM-5 for purposes of making light olefins. U.S. Pat. Nos. 5,095,163; 5,126,308 and 5,191,141 on the other hand, disclose an MTO conversion technology utilizing a non-zeolitic molecular sieve catalytic material, such as a metal aluminophosphate (ELAPO) molecular sieve. OTO and MTO processes, while useful, utilize an indirect process for forming a desired hydrocarbon product by first converting a feed to an oxygenate and subsequently converting the oxygenate to the hydrocarbon product. This indirect route of production is often associated with energy and cost penalties, often reducing the advantage gained by using a less expensive feed material.

Recently, attempts have been made to use pyrolysis to convert natural gas to ethylene. U.S. Pat. No. 7,183,451 discloses heating natural gas to a temperature at which a fraction is converted to hydrogen and a hydrocarbon product such as acetylene or ethylene. The product stream is then quenched to stop further reaction and subsequently reacted in the presence of a catalyst to form liquids to be transported. The liquids ultimately produced include naphtha, gasoline, or diesel. While this method may be effective for converting a portion of natural gas to acetylene or ethylene, it is estimated that this approach will provide only about a 40% yield of acetylene from a methane feed stream. While it has been identified that higher temperatures in conjunction with short residence times can increase the yield, technical limitations prevent further improvement to this process in this regard.

While the foregoing traditional pyrolysis systems provide solutions for converting ethane and propane into other useful hydrocarbon products, they have proven either ineffective or uneconomical for converting methane into these other products, such as, for example ethylene. While MTO technology is promising, these processes can be expensive due to the indirect approach of forming the desired product. Due to continued increases in the price of feeds for traditional processes, such as ethane and naphtha, and the abundant supply and corresponding low cost of natural gas and other methane sources available, for example the more recent accessibility of shale gas, it is desirable to provide commercially feasible and cost effective ways to use methane as a feed for producing ethylene and other useful hydrocarbons.

### BRIEF DESCRIPTION OF THE DRAWINGS

FIG. 1 is a side cross-sectional view of a supersonic reactor in accordance with various embodiments described herein;

FIG. 2 is a schematic view of a system for converting methane into acetylene and other hydrocarbon products in accordance with various embodiments described herein;

FIG. 3 is a side cross-sectional view of a supersonic reactor showing a mixer in accordance with various embodiments described herein; and

FIG. 4 is a partial side cross-sectional view of showing a portion of the supersonic reactor of FIG. 3 in accordance with various embodiments described herein.

### DETAILED DESCRIPTION

One proposed alternative to the previous methods of producing olefins that has not gained much commercial traction includes passing a hydrocarbon feedstock into a supersonic reactor and accelerating it to supersonic speed to provide kinetic energy that can be transformed into heat to enable an endothermic pyrolysis reaction to occur. Variations of this process are set out in U.S. Pat. Nos. 4,136,015 and 4,724,272; and Russian Patent No. SU 392723A. These processes include combusting a feedstock or carrier fluid in an oxygen-rich environment to increase the temperature of the feed and accelerate the feed to supersonic speeds. A shock wave is created within the reactor to initiate pyrolysis or cracking of the feed.

More recently, U.S. Pat. Nos. 5,219,530 and 5,300,216 have suggested a similar process that utilizes a shock wave reactor to provide kinetic energy for initiating pyrolysis of natural gas to produce acetylene. More particularly, this process includes passing steam through a heater section to become superheated and accelerated to a nearly supersonic speed. The heated fluid is conveyed to a nozzle which acts to expand the carrier fluid to a supersonic speed and lower temperature. An ethane feedstock is passed through a compressor and heater and injected by nozzles to mix with the supersonic carrier fluid to turbulently mix together at a speed of about Mach 2.8 and a temperature of about 427 C. The temperature in the mixing section remains low enough to restrict premature pyrolysis. The shockwave reactor includes a pyrolysis section with a gradually increasing cross-sectional area where a standing shock wave is formed by back pressure in the reactor due to flow restriction at the outlet. The shock wave rapidly decreases the speed of the fluid, correspondingly rapidly increasing the temperature of the mixture by converting the kinetic energy into heat. This immediately initiates pyrolysis of the ethane feedstock to convert it to other products. A quench heat exchanger then receives the pyrolized mixture to quench the pyrolysis reaction.

Methods and apparatus for converting hydrocarbon components in methane feed streams using a supersonic reactor are generally disclosed. As used herein, the term “methane feed stream” includes any feed stream comprising methane. The methane feed streams provided for processing in the supersonic reactor generally include methane and form at least a portion of a process stream. The apparatus and methods presented herein convert at least a portion of the methane to a desired product hydrocarbon compound to produce a product stream having a higher concentration of the product hydrocarbon compound relative to the feed stream.

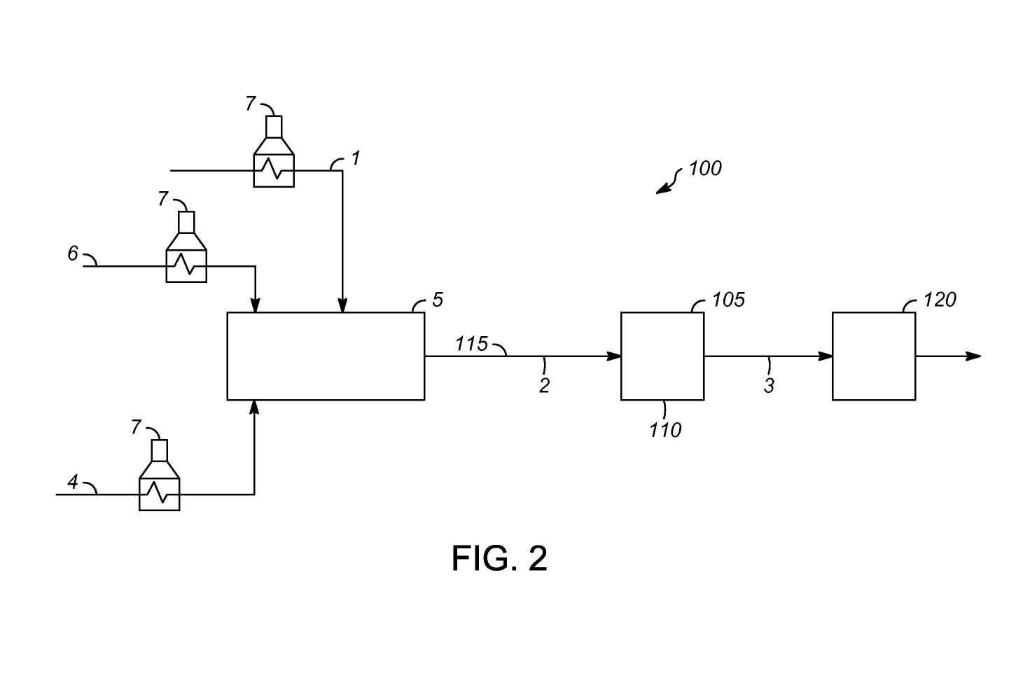

The term “hydrocarbon stream” as used herein refers to one or more streams that provide at least a portion of the methane feed stream entering the supersonic reactor as described herein or are produced from the supersonic reactor from the methane feed stream, regardless of whether further treatment or processing is conducted on such hydrocarbon stream. With reference to the example illustrated in FIG. 2, the “hydrocarbon stream” may include the methane feed stream 1, a supersonic reactor effluent stream 2, a desired product stream 3 exiting a downstream hydrocarbon conversion process or any intermediate or by-product streams formed during the processes described herein. The hydrocarbon stream may be carried via a process stream line 115, as shown in FIG. 2, which includes lines for carrying each of the portions of the process stream described above. The term “process stream” as used herein includes the “hydrocarbon stream” as described above, as well as it may include a carrier fluid stream, a fuel stream 4, an oxygen source stream 6, or any streams used in the systems and the processes described herein. The process stream may be carried via a process stream line 115, which includes lines for carrying each of the portions of the process stream described above. As illustrated in FIG. 2, any of methane feed stream 1, fuel stream 4, and oxygen source stream 6, may be preheated, for example, by one or more heaters 7.

Prior attempts to convert light paraffin or alkane feed streams, including ethane and propane feed streams, to other hydrocarbons using supersonic flow reactors have shown promise in providing higher yields of desired products from a particular feed stream than other more traditional pyrolysis systems. Specifically, the ability of these types of processes to provide very high reaction temperatures with very short associated residence times offers significant improvement over traditional pyrolysis processes. It has more recently been realized that these processes may also be able to convert methane to acetylene and other useful hydrocarbons, whereas more traditional pyrolysis processes were incapable or inefficient for such conversions.

The majority of previous work with supersonic reactor systems, however, has been theoretical or research based, and thus has not addressed problems associated with practicing the process on a commercial scale. In addition, many of these prior disclosures do not contemplate using supersonic reactors to effectuate pyrolysis of a methane feed stream, and tend to focus primarily on the pyrolysis of ethane and propane. One problem that has recently been identified with adopting the use of a supersonic flow reactor for light alkane pyrolysis, and more specifically the pyrolysis of methane feeds to form acetylene and other useful products therefrom, includes the difficulty of evenly mixing the feed stream with a hot carrier stream traveling through the supersonic reactor at supersonic speeds and evenly distributing the feed stream across the cross sectional area of the supersonic reactor. More particularly, due to the high speed of the carrier gas traveling through the reactor, the typical approach for injecting feed at the reactor shell around the periphery of the carrier stream results in the carrier stream drawing the feed stream quickly in the downstream direction before the feed is able to disperse across the reactor chamber.

Unfortunately, uneven distribution of the feed stream in the reactor and incomplete mixing of the feed stream with the carrier stream may result in portions of the feed stream reaching the pyrolysis temperature rapidly while other portions of the feed stream have minimal contact with carrier stream so that the temperatures of these portions may not reach the pyrolysis temperature or may take longer to reach the pyrolysis temperature. These inconsistent residence times during which different portions of the feed stream are heated to the pyrolysis temperature may result in reduced yield of acetylene as some of the methane will not undergo pyrolysis and will pass through the reactor unconverted, whilst some of the methane will continue pyrolysis beyond the production of acetylene to form other compounds, for example, coke or soot.

In accordance with various embodiments disclosed herein, therefore, apparatus and methods for converting methane in hydrocarbon streams to acetylene and other hydrocarbon products is provided. Apparatus in accordance herewith, and the use thereof, have been identified to improve the overall process for the pyrolysis of light alkane feeds, including methane feeds, to acetylene and other useful hydrocarbon products. The apparatus and processes described herein also beneficially improves mixing of the methane feed stream with a carrier stream in the supersonic reactor to improve dispersion and mixing of the methane feed stream and ultimately to improve the yield of hydrocarbon products.

In accordance with one approach, the apparatus and methods disclosed herein are used to treat a hydrocarbon process stream to convert at least a portion of methane in the hydrocarbon process stream to acetylene. The hydrocarbon process stream described herein includes the methane feed stream provided to the system, which includes methane and may also include ethane or propane. The methane feed stream may also include combinations of methane, ethane, and propane at various concentrations and may also include other hydrocarbon compounds as well as contaminants. In one approach, the hydrocarbon feed stream includes natural gas. The natural gas may be provided from a variety of sources including, but not limited to, gas fields, oil fields, coal fields, fracking of shale fields, biomass, and landfill gas. In another approach, the methane feed stream can include a stream from another portion of a refinery or processing plant. For example, light alkanes, including methane, are often separated during processing of crude oil into various products and a methane feed stream may be provided from one of these sources. These streams may be provided from the same refinery or different refinery or from a refinery off gas. The methane feed stream may include a stream from combinations of different sources as well.

In accordance with the processes and systems described herein, a methane feed stream may be provided from a remote location or at the location or locations of the systems and methods described herein. For example, while the methane feed stream source may be located at the same refinery or processing plant where the processes and systems are carried out, such as from production from another on-site hydrocarbon conversion process or a local natural gas field, the methane feed stream may be provided from a remote source via pipelines or other transportation methods. For example a feed stream may be provided from a remote hydrocarbon processing plant or refinery or a remote natural gas field, and provided as a feed to the systems and processes described herein. Initial processing of a methane stream may occur at the remote source to remove certain contaminants from the methane feed stream. Where such initial processing occurs, it may be considered part of the systems and processes described herein, or it may occur upstream of the systems and processes described herein. Thus, the methane feed stream provided for the systems and processes described herein may have varying levels of contaminants depending on whether initial processing occurs upstream thereof.

In one example, the methane feed stream has a methane content ranging from about 65 mol-% to about 100 mol-%. In another example, the concentration of methane in the hydrocarbon feed ranges from about 80 mol-% to about 100 mol-% of the hydrocarbon feed. In yet another example, the concentration of methane ranges from about 90 mol-% to about 100 mol-% of the hydrocarbon feed.

In one example, the concentration of ethane in the methane feed ranges from about 0 mol-% to about 35 mol-% and in another example from about 0 mol-% to about 10 mol-%. In one example, the concentration of propane in the methane feed ranges from about 0 mol-% to about 5 mol-% and in another example from about 0 mol-% to about 1 mol-%.

The methane feed stream may also include heavy hydrocarbons, such as aromatics, paraffinic, olefinic, and naphthenic hydrocarbons. These heavy hydrocarbons if present will likely be present at concentrations of between about 0 mol-% and about 100 mol-%. In another example, they may be present at concentrations of between about 0 mol-% and 10 mol-% and may be present at between about 0 mol-% and 2 mol-%.

The apparatus and method for forming acetylene from the methane feed stream described herein utilizes a supersonic flow reactor for pyrolyzing methane in the feed stream to form acetylene. The supersonic flow reactor may include one or more reactors capable of creating a supersonic flow of a carrier fluid and the methane feed stream and expanding the carrier fluid to initiate the pyrolysis reaction. In one approach, the process may include a supersonic reactor as generally described in U.S. Pat. No. 4,724,272, which is incorporated herein by reference, in its entirety. In another approach, the process and system may include a supersonic reactor such as described as a “shock wave” reactor in U.S. Pat. Nos. 5,219,530 and 5,300,216, which are incorporated herein by reference, in their entirety. In yet another approach, the supersonic reactor described as a “shock wave” reactor may include a reactor such as described in “Supersonic Injection and Mixing in the Shock Wave Reactor” Robert G. Cerff, University of Washington Graduate School, 2010.

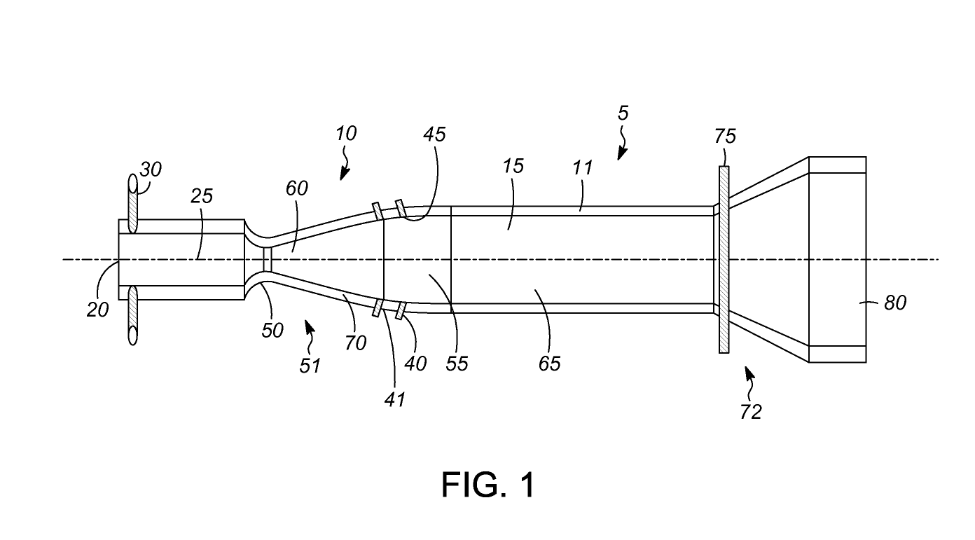

While a variety of supersonic reactors may be used in the present process, an exemplary reactor 5 is illustrated in FIG. 1. Referring to FIG. 1, the supersonic reactor 5 includes a reactor vessel 10 generally defining a reactor chamber 15. While the reactor 5 is illustrated as a single reactor, it should be understood that it may be formed modularly or as separate vessels. If formed modularly or as separate components, the modules or separate components of the reactor may be joined together permanently or temporarily, or may be separate from one another with fluids contained by other means, such as, for example, differential pressure adjustment between them. A combustion zone or chamber 25 is provided for combusting a fuel to produce a carrier fluid with the desired temperature and flowrate. The reactor 5 may optionally include a carrier fluid inlet 20 for introducing a supplemental carrier fluid into the reactor. One or more fuel injectors 30 are provided for injecting a combustible fuel, for example hydrogen, into the combustion chamber 25. The same or other injectors may be provided for injecting an oxygen source into the combustion chamber 25 to facilitate combustion of the fuel. The fuel and oxygen are combusted to produce a hot carrier fluid stream typically having a temperature of from about 1200 to about 3500 C in one example, between about 2000 and about 3500 in another example, and between about 2500 and about 3200 C in yet another example. It is also contemplated herein to produce the hot carrier fluid stream by other known methods, including non-combustion methods. According to one example the carrier fluid stream has a pressure of about 1 atm or higher, greater than about 2 atm in another example, and greater than about 4 atm in another example.

The hot carrier fluid stream from the combustion zone 25 is passed through a supersonic expander 51 that includes a converging-diverging nozzle 50 to accelerate the flowrate of the carrier fluid to above about mach 1.0 in one example, between about mach 1.0 and mach 4.0 in another example, and between about mach 1.5 and 3.5 in another example. In this regard, the residence time of the fluid in the reactor portion of the supersonic flow reactor is between about 0.5-100 ms in one example, about 1.0-50 ms in another example, and about 1.5-20 ms in another example. The temperature of the carrier fluid stream through the supersonic expander by one example is between about 1000 C and about 3500 C, between about 1200 C and about 2500 C in another example, and between about 1200 C and about 2000 C in another example.

A feedstock inlet 40 is provided for injecting the methane feed stream into the reactor 5 to mix with the carrier fluid. The feedstock inlet 40 may include one or more injectors 45 for injecting the feedstock into the nozzle 50, a mixing zone 55, a diffuser zone 60, or a reaction zone or chamber 65. The injector 45 may include a manifold, including for example a plurality of injection ports or nozzles for injecting the feed into the reactor 5.

In one approach, the reactor 5 may include a mixing zone 55 for mixing of the carrier fluid and the feed stream. In one approach, as illustrated in FIG. 1, the reactor 5 may have a separate mixing zone, between for example the supersonic expander 51 and the diffuser zone 60, while in another approach, the mixing zone is integrated into the diffuser section is provided, and mixing may occur in the nozzle 50, expansion zone 60, or reaction zone 65 of the reactor 5. An expansion zone 60 includes a diverging wall 70 to produce a rapid reduction in the velocity of the gases flowing therethrough, to convert the kinetic energy of the flowing fluid to thermal energy to further heat the stream to cause pyrolysis of the methane in the feed, which may occur in the expansion section 60 and/or a downstream reaction section 65 of the reactor. The fluid is quickly quenched in a quench zone 72 to stop the pyrolysis reaction from further conversion of the desired acetylene product to other compounds. Spray bars 75 may be used to introduce a quenching fluid, for example water or steam into the quench zone 72.

The reactor effluent exits the reactor via outlet 80 and as mentioned above forms a portion of the hydrocarbon stream. The effluent will include a larger concentration of acetylene than the feed stream and a reduced concentration of methane relative to the feed stream. The reactor effluent stream may also be referred to herein as an acetylene stream as it includes an increased concentration of acetylene. The acetylene stream may be an intermediate stream in a process to form another hydrocarbon product or it may be further processed and captured as an acetylene product stream. In one example, the reactor effluent stream has an acetylene concentration prior to the addition of quenching fluid ranging from about 2 mol-% to about 30 mol-%. In another example, the concentration of acetylene ranges from about 5 mol-% to about 25 mol-% and from about 8 mol-% to about 23 mol-% in another example.

The reactor vessel 10 includes a reactor shell 11. It should be noted that the term “reactor shell” refers to the wall or walls forming the reactor vessel, which defines the reactor chamber 15. The reactor shell 11 will typically be an annular structure defining a generally hollow central reactor chamber 15. The reactor shell 11 may include a single layer of material, a single composite structure or multiple shells with one or more shells positioned within one or more other shells. The reactor shell 11 also includes various zones, components, and or modules, as described above and further described below for the different zones, components, and or modules of the supersonic reactor 5. The reactor shell 11 may be formed as a single piece defining all of the various reactor zones and components or it may be modular, with different modules defining the different reactor zones and/or components.

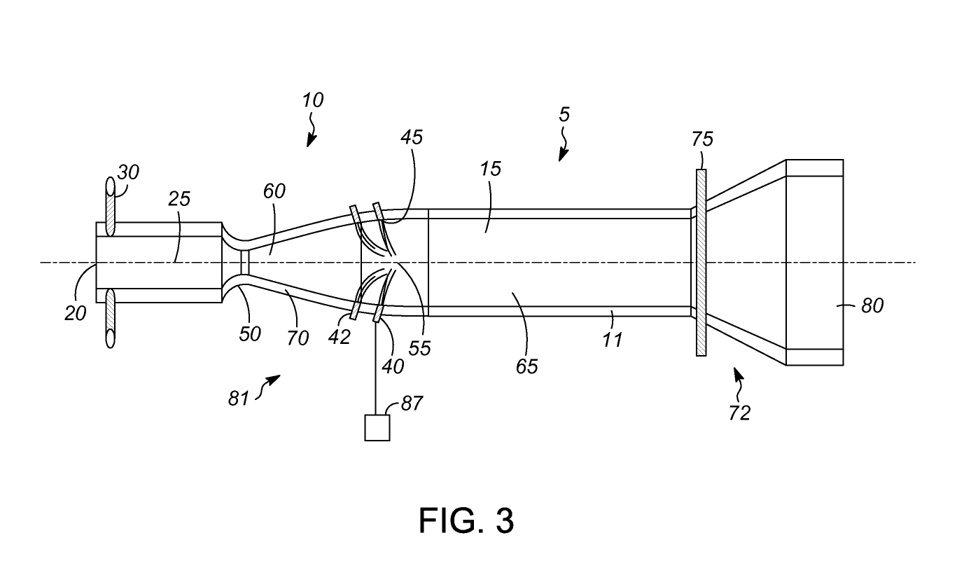

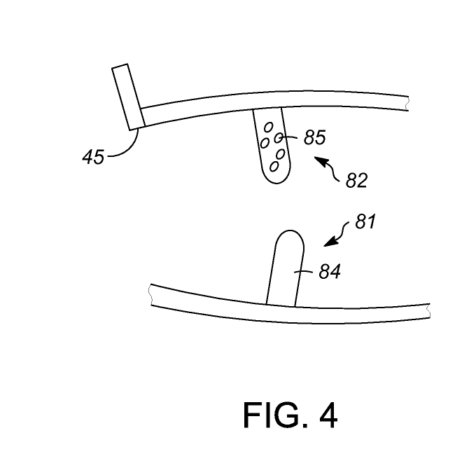

In one approach, as illustrated in FIGS. 3 and 4, a mixer 81 is provided for mixing the methane feed stream with the carrier stream to form a pyrolysis stream. Advantageously, the mixer 81 provides thorough mixing of the feed stream with the carrier stream and more even distribution of the feed stream across the cross section of the reactor chamber 25.

To add to the difficulty of sufficiently mixing the feed stream with the carrier stream over a short amount of time and distance, with the carrier stream traveling at supersonic speeds, another particular problem includes the damaging effects that the severe operating conditions for pyrolysis of the methane can have on any mixing devices or apparatus that are used in the process. For example, the supersonic reactor may operate at temperature up to 3000 C or higher, along with high pressures. These high temperatures and pressures pose a risk for rapid deterioration or failure of any mixing devices used within the reaction chamber 25. In addition, a carrier stream and feed stream may travel through the reactor 5 at supersonic speeds, which can quickly erode many materials that could be used to form the mixers.

In one approach, the mixer includes a static mixer 82 as illustrated in FIG. 4. The static mixer 82 may include a portion 83 that extends into the reactor chamber to effectuate mixing of one or more of the streams traveling downstream there through. In one approach, the portion includes a flow manipulator 84 that has at least a portion thereof extending into the reaction chamber to contact at least one of the carrier gas, the methane feed stream, and the pyrolysis stream to manipulate the flow thereof. The static mixer 82, including the flow manipulator 84, may be positioned downstream of the feed inlet 40 to contact both the feed stream and the carrier stream for mixing the two streams together. Alternatively, the static mixer 82 may be positioned upstream of the position of the feed inlet 40 to modify the flow pattern of the carrier stream to effectuate better mixing of the carrier stream with the feed stream when the feed stream is introduced. A plurality of static mixers may also be used, being positioned at different positions relative to the feed inlet 40.

A variety of structures are contemplated herein for the flow manipulator 84, including, but not limited to fins, vanes, blades, baffles, helical mixers, vortex mixers, and the like. The flow manipulator may also be provided in various orientations and have various shapes to enhance mixing of the streams. Further, the flow manipulator 84 may extend only partway into the reactor chamber 25 or may extend across the reactor chamber 25 to another side or wall of the reactor shell 11. Other static mixers 82 as are generally known in the art are also contemplated herein. In one example, the static mixer 82 includes a vortex mixer and is configured to create a vortex flow of at least one of the carrier gas, the methane feed stream, and the pyrolysis stream traveling downstream to improve mixing thereof. According to another example, the static mixer 82 includes a turbulent flow device, and is configured to create turbulent flow of at least one of the streams to enhance mixing of the feed stream and the carrier stream.

In one approach, at least a portion of the flow manipulator 84 extending into the reactor chamber 25 is formed as a casting. Not to be bound by theory, it is believed that forming the at least portion of the flow manipulator 84 from the casting may reduce the amount of defects in the flow manipulator 84 and provide a more uniform grain structure so that the flow manipulator 84 is better able to withstand the operating conditions within the reactor chamber 25.

According to one approach, at least a portion of the flow manipulator 84 is formed of a superalloy. Suitable materials for forming the flow manipulator 84 may also include a carbide, a nitride, titanium diboride, a sialon, ceramic, zirconia, thoria, the carbon-carbon composite, tungsten, tantalum, molybdenum, chromium, nickel, and alloys thereof, and other related materials known in the art. Other suitable materials for forming the flow manipulator 84 may include duplex stainless steel, super duplex stainless steel, and nickel-based high-temperature low creep superalloy and other related materials known in the art. Similarly, it is believed that forming the flow manipulator 84 from these and other related materials enables the flow manipulator 84 to better withstand the high temperatures and flow rates within the reactor chamber 25.

By another approach, at least a portion of the flow manipulator 84 is detachable from the supersonic reactor 5 to allow replacement thereof after deterioration due to reactor chamber operation conditions. In this regard, if the flow manipulator 84 is degraded during operation of the supersonic flow reactor 5, due to, for example, erosion, corrosion, oxidation, or mechanical degradation or failure, the flow manipulator 84 may be removed, and a replacement flow manipulator may be incorporated into the supersonic flow reactor 5 to provide enhanced mixing of the feed stream and the carrier stream.

According to another approach, a film may be provided that covers at least a portion the flow manipulator 84 to reduce deterioration thereof due to reactor chamber operation conditions, including elevated temperatures and flowrates. In one approach, the film includes a cool fluid layer. More particularly, the cool fluid layer may include, for example, molten metal, water, air, hydrogen, and methane. The cool fluid layer may be formed by passing a cool fluid along the surface of the flow manipulator 84. In one approach, the cool fluid is passed through openings 85 in the flow manipulator 84. The openings 85 may be formed by providing a porous wall of the flow manipulator or by machining or otherwise forming the openings in the flow manipulator 84. As used herein, the term cool fluid means cool relative to the fluid stream in the reaction chamber 25, and includes fluids that have a lower temperature than the temperature of the process stream passing through the reactor 5. Dependent on the material selected for the flow manipulator, the cool fluid is designed to limit the maximum operating temperature of the flow manipulator material to be within acceptable limits of the material selected to maintain material integrity at elevated temperature. In one example, the cool fluid may be at a temperature sufficient for this task. The cool fluid advantageously may provide some protection of the flow manipulator from the high flowrate fluids flowing through the reaction chamber 25, and may also reduce the temperature seen by the outer skin or surface of the flow manipulator.

According to another approach, the flow manipulator includes internal channels for circulating a cooling fluid such as water, methane, hydrogen, oxygen, or any other appropriate heat transfer fluid. The cooling fluid will be circulated through the cooling channels contained within the structure of the flow manipulator to maintain the wall temperature of the flow manipulator at a sufficiently low temperature to maintain the integrity of the device. This approach may enable the use of materials that would otherwise be inappropriate at the desired temperatures.

The mixer 81 may also include a variety of other types of mixers as generally known in the art. By one aspect, as illustrated in FIG. 3, the mixer may be an indirect mixer 90 positioned inside or outside of the reaction chamber 25.

In one approach, the indirect mixer 90 may include a microwave generator for generating a microwave for mixing the feed stream with the carrier stream. According to other approaches, the indirect mixer 90 may include an ultrasound generator, a supersonic flow generator, or an ultrasonic flow generator for mixing the feed stream with the carrier stream.

In yet another approach, the indirect mixer 90 includes a vortex mixer positioned in the supersonic expander for producing a vortex flow of the carrier stream. In another approach, the supersonic reactor includes a rifled expander for mixing the feed stream with the carrier stream. By another approach, the indirect mixer 90 includes a cyclonic mixer whereby the feed stream is drawn into a vacuum of an induced vortex generated by the cyclonic mixer.

In another approach, the feed stream is injected into the reaction chamber 25 in various manners to induce enhanced mixing of the feed stream and the carrier stream. In one approach, a feed injection device 41 is provided for introducing the methane feed stream into the reactor chamber 25 and mixing the feed stream with the carrier stream to provide a pyrolysis stream. Advantageously, the feed injection device 41 provides enhanced mixing of the feed stream with the carrier stream with or without the use of additional mixing devices.

In one approach, the supersonic reactor 5 includes a mixing section 55 and the feed injection device 41 is positioned upstream of the mixing section 55 to provide for mixing of the feed stream with carrier stream and the mixing section 55. In another approach, the feed injection device 41 is positioned downstream of the mixing section 55, such that the carrier stream is mixed to provide a flow pattern that will enhance mixing of the feed stream with the carrier stream when the feed stream is ultimately introduced. In yet another approach, the feed injection device 41 is positioned in the diffuser section 60 of the reactor chamber 25.

According to other approaches, mixing of the feed stream with the carrier stream is enhanced by introducing the feed stream in various orientations. In one approach, the feed injection device 41 is configured to inject the feed stream downstream tangentially along the fluid flowpath. In another approach, the feed injection device 41 is configured to inject the feed stream generally radially toward an axis of the reaction chamber into the fluid flowpath. In yet another approach, the feed injection device 41 is configured to inject the feed stream generally circumferentially about an annular inner surface of the reactor shell 11. In another approach, the feed injection device 41 is configured to disperse the feed into the reaction chamber in two or more directions.

According to another approach, to provide for better dispersion of the feed stream throughout the reactor chamber 25 and mixing with the carrier stream, in an inert gas injector 42 may be provided for injecting an inert gas into the reaction chamber 25 to at least partially shield feed injected from the feed injection device from fluid flowing through the reactor. As illustrated in FIG. 3, the inert gas injector 42 is positioned upstream of the injection device 41, such that an inert gas is injected into the reaction chamber 25 upstream of the feed stream to at least partially interrupt the flow of the carrier stream to allow the feed stream to penetrate further into the reaction chamber 25. It should be noted, that while the inert gas injector 42 as illustrated as being separate and upstream of the feed injection device 41 it may be combined with the feed injection device such that the inert gas is injected with the feed or near the feed from the feed injection device 41 or may be downstream of the feed injection device 41 so as to disrupt the flow and induce mixing after the introduction of the feed stream.

According to other approaches, various apparatus and processes are used to excite and or accelerate the feed stream as it is injected by the injection device 41 to provide for enhanced dispersion throughout the reactor chamber 25 and mixing with the carrier fluid. According to some of these approaches, a feed injection enhancer 87 is provided to enhance the flow of feed into the reaction chamber 25 to improve dispersion and mixing thereof. Various approaches for a feed injection enhancer 87 are now described. In one approach, an infrared laser configured to generate an infrared beam to contact the feed stream entering the reactor chamber and enhance mixing of the feed stream with the carrier stream is provided. In another approach, an electric field generator is provided and configured to produce an electric field for enhancing mixing of the feed stream entering the reactor chamber 25 and the carrier fluid. In yet another approach, an ion beam generator is provided and configured to generate an ion beam to contact the feed stream entering the reactor chamber and enhance mixing of the feed stream with the carrier stream. In a further approach, a molecular electrophoresis generator is provided and configured to produce electrophoresis of the feed stream entering the reactor chamber and enhance mixing of the feed stream with the carrier stream. In yet another approach, a heavy molecule injector is provided for injecting a heavy molecule stream into the reactor with the feed stream to transfer momentum to the feed stream and enhance mixing thereof with the carrier stream. These methods of inducing mixing are familiar to those skilled in the art.

In one example, the reactor effluent stream after pyrolysis in the supersonic reactor 5 has a reduced methane content relative to the methane feed stream ranging from about 15 mol-% to about 95 mol-%. In another example, the concentration of methane ranges from about 40 mol-% to about 90 mol-% and from about 45 mol-% to about 85 mol-% in another example.

In one example the yield of acetylene produced from methane in the feed in the supersonic reactor is between about 40% and about 95%. In another example, the yield of acetylene produced from methane in the feed stream is between about 50% and about 90%. Advantageously, this provides a better yield than the estimated 40% yield achieved from previous, more traditional, pyrolysis approaches.

By one approach, the reactor effluent stream is reacted to form another hydrocarbon compound. In this regard, the reactor effluent portion of the hydrocarbon stream may be passed from the reactor outlet to a downstream hydrocarbon conversion process for further processing of the stream. While it should be understood that the reactor effluent stream may undergo several intermediate process steps, such as, for example, water removal, adsorption, and/or absorption to provide a concentrated acetylene stream, these intermediate steps will not be described in detail herein.

Referring to FIG. 2, the reactor effluent stream having a higher concentration of acetylene may be passed to a downstream hydrocarbon conversion zone 100 where the acetylene may be converted to form another hydrocarbon product. The hydrocarbon conversion zone 100 may include a hydrocarbon conversion reactor 105 for converting the acetylene to another hydrocarbon product. While FIG. 2 illustrates a process flow diagram for converting at least a portion of the acetylene in the effluent stream to ethylene through hydrogenation in hydrogenation reactor 110, it should be understood that the hydrocarbon conversion zone 100 may include a variety of other hydrocarbon conversion processes instead of or in addition to a hydrogenation reactor 110, or a combination of hydrocarbon conversion processes. Similarly, unit operations illustrated in FIG. 2 may be modified or removed and are shown for illustrative purposes and not intended to be limiting of the processes and systems described herein. Specifically, it has been identified that several other hydrocarbon conversion processes, other than those disclosed in previous approaches, may be positioned downstream of the supersonic reactor 5, including processes to convert the acetylene into other hydrocarbons, including, but not limited to: alkenes, alkanes, methane, acrolein, acrylic acid, acrylates, acrylamide, aldehydes, polyacetylides, benzene, toluene, styrene, aniline, cyclohexanone, caprolactam, propylene, butadiene, butyne diol, butandiol, C2-C4 hydrocarbon compounds, ethylene glycol, diesel fuel, diacids, diols, pyrrolidines, and pyrrolidones.

A contaminant removal zone 120 for removing one or more contaminants from the hydrocarbon or process stream may be located at various positions along the hydrocarbon or process stream depending on the impact of the particular contaminant on the product or process and the reason for the contaminants removal, as described further below. For example, particular contaminants have been identified to interfere with the operation of the supersonic flow reactor 5 and/or to foul components in the supersonic flow reactor 5. Thus, according to one approach, a contaminant removal zone is positioned upstream of the supersonic flow reactor in order to remove these contaminants from the methane feed stream prior to introducing the stream into the supersonic reactor. Other contaminants have been identified to interfere with a downstream processing step or hydrocarbon conversion process, in which case the contaminant removal zone may be positioned upstream of the supersonic reactor or between the supersonic reactor and the particular downstream processing step at issue. Still other contaminants have been identified that should be removed to meet particular product specifications. Where it is desired to remove multiple contaminants from the hydrocarbon or process stream, various contaminant removal zones may be positioned at different locations along the hydrocarbon or process stream. In still other approaches, a contaminant removal zone may overlap or be integrated with another process within the system, in which case the contaminant may be removed during another portion of the process, including, but not limited to the supersonic reactor 5 or the downstream hydrocarbon conversion zone 100. This may be accomplished with or without modification to these particular zones, reactors or processes. While the contaminant removal zone 120 illustrated in FIG. 2 is shown positioned downstream of the hydrocarbon conversion reactor 105, it should be understood that the contaminant removal zone 120 in accordance herewith may be positioned upstream of the supersonic flow reactor 5, between the supersonic flow reactor 5 and the hydrocarbon conversion zone 100, or downstream of the hydrocarbon conversion zone 100 as illustrated in FIG. 2 or along other streams within the process stream, such as, for example, a carrier fluid stream, a fuel stream, an oxygen source stream, or any streams used in the systems and the processes described herein.

While there have been illustrated and described particular embodiments and aspects, it will be appreciated that numerous changes and modifications will occur to those skilled in the art, and it is intended in the appended claims to cover all those changes and modifications which fall within the true spirit and scope of the present disclosure and appended claims.

What is claimed is:

1. An apparatus for producing acetylene from a feed stream comprising methane comprising:
a supersonic reactor for receiving the methane feed stream and heating the methane feed stream to a pyrolysis temperature;
a reactor shell of the supersonic reactor defining a reactor chamber;
a combustion zone of the supersonic reactor having a combustion chamber for combusting a fuel source to provide a high temperature carrier gas passing through the reactor chamber in a downstream direction along a fluid flowpath at supersonic speeds to heat and accelerate the methane feed stream to a pyrolysis temperature; and
a feed injection device for introducing the methane feed stream into the reactor chamber and mixing the feed stream with the carrier stream to provide a pyrolysis stream.

2. The apparatus of claim 1, wherein the supersonic reactor includes a mixing section and the feed injection device is positioned upstream of the mixing section.

3. The apparatus of claim 1, wherein the supersonic reactor includes a mixing section and the feed injection device is positioned downstream of the mixing section.

4. The apparatus of claim 1, wherein the supersonic reactor includes a diffuser section and the feed injection device is positioned in the diffuser section of the reactor chamber having a diverging cross sectional area.

5. The apparatus of claim 1, wherein the reactor shell has a generally annular configuration defining a generally cylindrical reaction chamber and the feed injection device is configured to inject the feed stream downstream tangentially along the fluid flowpath.

6. The apparatus of claim 1, wherein the reactor shell has a generally annular configuration defining a generally cylindrical reaction chamber and the feed injection device is configured to inject the feed stream generally radially toward an axis of the reaction chamber into the fluid flowpath.

7. The apparatus of claim 1, wherein the reactor shell has a generally annular configuration defining a generally cylindrical reaction chamber and the feed injection device is configured to inject the feed stream generally circumferentially about an annular inner surface of the reactor shell.

8. The apparatus of claim 1, wherein the feed injection device is configured to disperse the feed into the reaction chamber in two or more directions.

9. The apparatus of claim 1, further comprising an inert gas injector configured to inject an inert gas into the reaction chamber to at least partially shield feed injected from the feed injection device from fluid flowing through the reactor.

10. The apparatus of claim 1, further comprising an infrared laser configured to generate an infrared beam to contact the feed stream entering the reactor chamber and enhance mixing of the feed stream with the carrier stream.

11. The apparatus of claim 1, further comprising an electric field generator configured to produce an electric field for enhancing mixing of the feed stream entering the reactor chamber and the carrier fluid.

12. The apparatus of claim 1, further comprising an ion beam generator configured to generate an ion beam to contact the feed stream entering the reactor chamber and enhance mixing of the feed stream with the carrier stream.

13. The apparatus of claim 1, further comprising a molecular electrophoresis generator configured to produce electrophoresis of the feed stream entering the reactor chamber and enhance mixing of the feed stream with the carrier stream.

14. The apparatus of claim 1, further comprising a heavy molecule injector for injecting a heavy molecule stream into the reactor with the feed stream to transfer momentum to the feed stream and enhance mixing thereof with the carrier stream.

15. A method for producing acetylene comprising:
introducing a fuel stream into a combustion zone of a supersonic reactor;
combusting the fuel stream to provide a high temperature carrier stream traveling at a supersonic speed;
introducing a feed stream portion of a hydrocarbon stream comprising methane into the supersonic reactor; and
mixing the feed stream with the carrier stream to form a pyrolysis stream.

16. The method of claim 15, wherein introducing the feed stream includes providing an inert gas shield about at least a portion of the feed stream.

17. The method of claim 15, wherein mixing the feed stream with the carrier stream includes injecting the feed stream into the reactor chamber using molecular electrophoresis enhanced mixing.

18. The method of claim 15, wherein mixing the feed stream with the carrier stream includes directing an ion beam at the feed stream as it is introduced into the supersonic reactor to enhance mixing.

19. The method of claim 15, wherein mixing the feed stream with the carrier stream includes directing a laser beam at the feed stream as it is introduced into the supersonic reactor to enhance mixing.

20. The method of claim 15, wherein mixing the feed stream with the carrier stream includes directing a heavy molecule stream at the feed stream as it is introduced into the supersonic reactor to transfer momentum to the feed stream and enhance mixing thereof with the carrier stream.
